(19) United States
(12) Patent Application Publication
(10) Pub. No.: US 2006/0158799 A1
(43) Pub. Date: Jul. 20, 2006

(54) High current ground fault circuit interrupter with open neutral detection

(76) Inventors: David Y. Chan, Bellrose, NY (US); William Grande, Great Neck, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/322,236

(22) Filed: Dec. 30, 2005

Related U.S. Application Data
(60) Provisional application No. 60/640,753, filed on Dec. 30, 2004.

(51) Int. Cl. H02H 3/00

(52) U.S. Cl. 361/42

(57) ABSTRACT

Open neutral conductor protection of a 3 phase circuit is obtained by coupling the 3 phase conductors and the neutral conductor of the three phase circuit to a high current GFCI and using power from two of the phases of the 3 phase circuit as the source of power for the high current GFCI. A voltage reducing means such as a step down transformer is connected across two phases of the 3-phase circuit to convert the high voltage, such as 208 volts, across the two phases to 120 volts which is used as the input power for the circuit of the High Current GFCI. In operation, the circuit of the GFCI derives its input power from two separate phases of the 3-phase circuit and, therefore, when an open neutral fault occurs, the supply voltage to the GFCI is not interrupted and the GFCI can continue to provide protection for the system.

This application claims the benefit of the filing date of provisional application having Ser. No. 60/640,753 which was filed on Dec. 30, 2004.

### BACKGROUND OF THE INVENTION

1. Field of the Invention

This invention relates generally to ground fault circuit interrupters (GFCI's) and more specifically to a high current GFCI which can detect an open neutral condition.

2. Description of the Prior Art

A GFCI can be connected to a multi-phase circuit such as a 3-phase circuit to provide open neutral conductor protection. However, a situation can occur where the GFCI will not trip when an open neutral situation occurs. Some devices use a continuous relay with power line drive to sense for the occurrence of a broken power supply conductor. This method is adequate for single phase power applications. In some instances, if a broken neutral on the power cable should occur when this method of protection is used with a multi-phase circuit, the relay may not drop out. If, at this time, an unbalanced loading condition should also occur, the GFCI may not be able to provide Ground Fault protection. A ground fault protection system that avoids the above noted problem is needed.

### SUMMARY OF THE INVENTION

Open neutral conductor protection of a 3 phase circuit is obtained by coupling the 3 phase conductors and the neutral conductor of the three phase circuit to a high current GFCI and using power from two of the phases of the 3 phase circuit as the source of power for the high current GFCI. A voltage reducing means such as a step down transformer is connected across two phases of the 3-phase circuit to convert the high voltage, such as 208 volts, across the two phases to 120 volts which is used as the input power for the circuit of the High Current GFCI. In operation, the circuit of the GFCI derives its input power from two separate phases of the 3-phase circuit and, therefore, when an open neutral fault occurs, the supply voltage to the GFCI is not interrupted and the GFCI can continue to provide protection for the system.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention is its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals

FIG. 1 is a perspective view of a high current ground fault circuit interrupter (GFCI) of the present invention;

FIG. 2 is a schematic diagram of the basic system of the present invention when used to protect a 3 phase circuit;

FIG. 3 is a detailed schematic of the system shown in prior art circuits which can be used to implement the ground fault circuit interrupter diagram of FIG. 2;

FIG. 4 is a side view of the high current ground fault circuit interrupter of FIG. 1;

FIG. 5 is a bottom view, partially in section, of FIG. 4 taken along the line 5-5 of FIG. 4; and

FIG. 6 is a combined front elevation view and prospective view of separate portions of the device of FIG. 1.

### DESCRIPTION OF THE PREFERRED EMBODIMENT

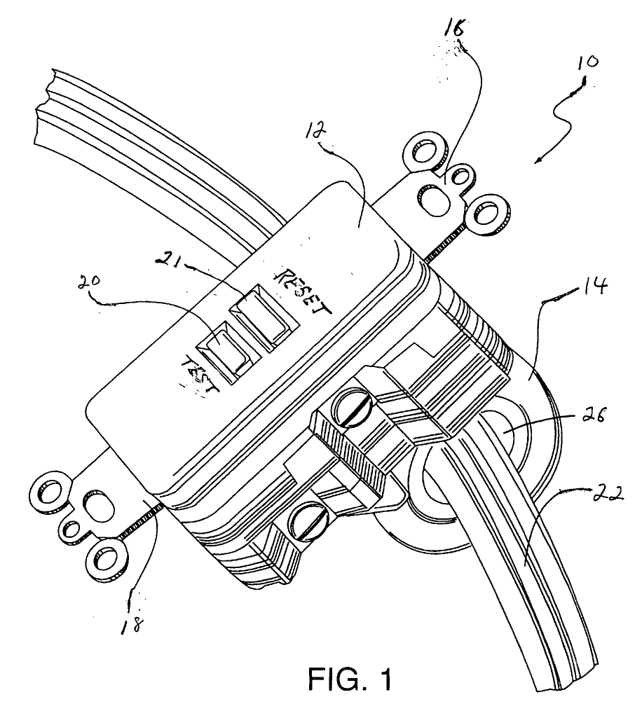

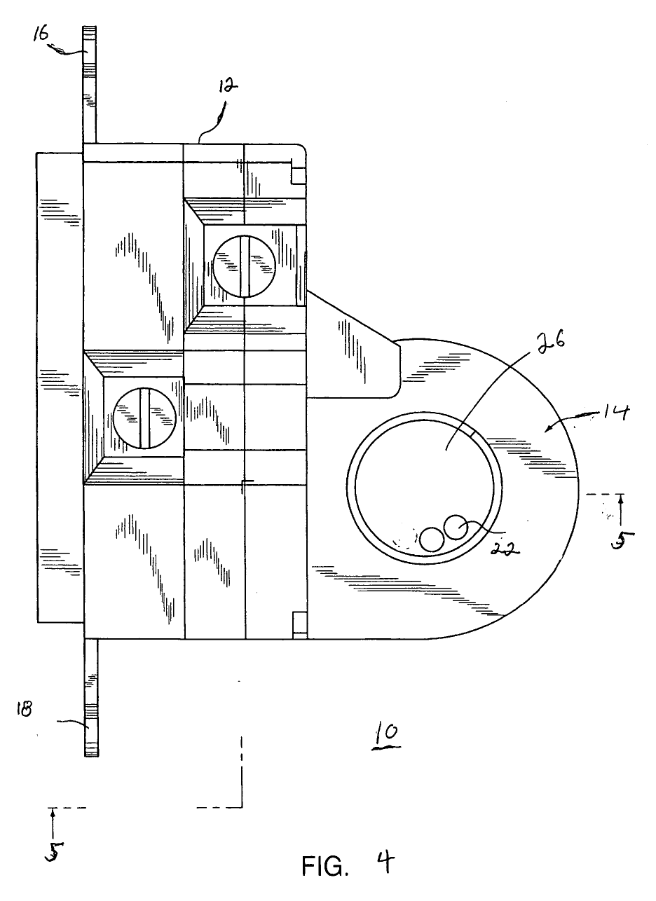

Referring to FIGS. 1, 4 and 5, there is shown a high current ground fault circuit interrupter 10 such as, for example, the high current GFCI by Leviton (Cat. No. 6895) having a housing compartment 12 in which the ground fault interrupter circuitry is located, and a sensor compartment 14 in which a differential transformer and a neutral transformer are located. Mounting ears 16 and 18, as well as test push button 20, and reset push button 21 are also shown. The separate compartmentalization of the ground fault interrupter circuitry and the transformers of the GFCI 10 allows a plurality of high current conductors 22 to be passed through the sensor housing 14 of the ground fault circuit interrupter. In the prior art, such high current carrying conductors, i.e., conductors which carry substantially 20 to 50 amps, could not be used with ground fault circuit interrupters having the size of the GFCI here identified, which has contacts rated at only 20 amps.

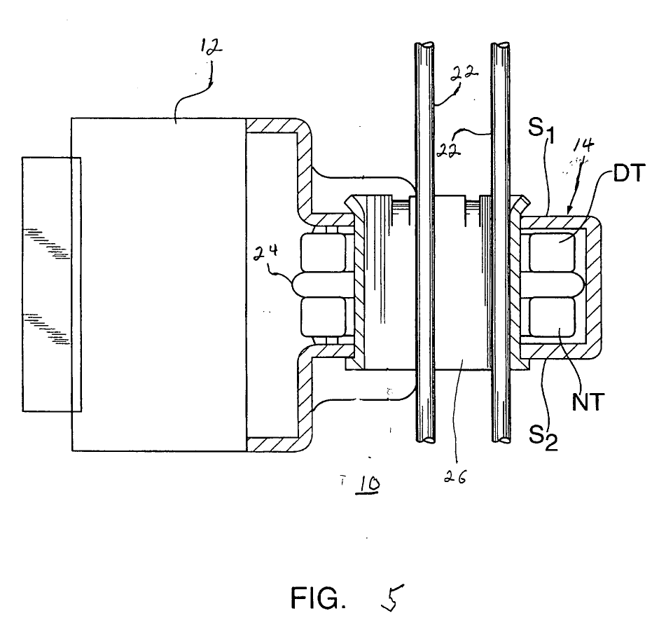

The differential transformer DT and the neutral transformer NT, as shown as in FIG. 5 are located in a compartment 14 made up of two half shells S1 and S2 which, when joined at their open long sides form a hollow toroid about the cores of the transformers DT and NT. Transformers DT,NT are held parallel to each other by a separator or spacer 24. The half shells S1 and S2 may be held in assembly by any conventional fastener, adhesive, etc.

Compartment 14 can be fastened to the back of the housing compartment 12 by any conventional means such as adhesives, fasteners, etc. The secondary windings of transformers DT and NT (not shown) are connected to the ground fault circuit interrupter circuitry in housing compartment 12. The individual conductors 22 can be fed through aperture 26 in compartment 14, where they act as the one turn primary winding for the transformers DT and NT.

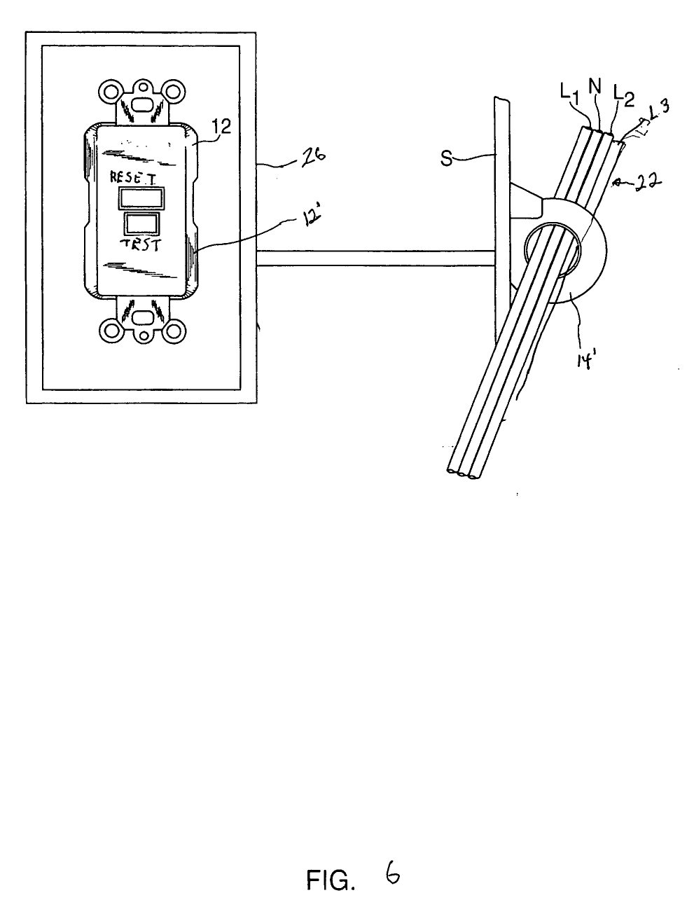

The arrangement of FIGS. 1, 4 and 5 places the conductors 22 in sensor housing 14 close to the housing compartment 12 where the circuitry for the ground fault circuit interrupter is located. It is to be noted that this proximity is not required. In FIG. 6, the ground fault circuit interrupter circuitry is in a compartment 12′ located in a control panel 26 at one location, while the transformer DT, NT in compartment 14′ is located remote from panel 26 and at a location that can be closer to the load and the contacts of the contactor as will be further discussed below.

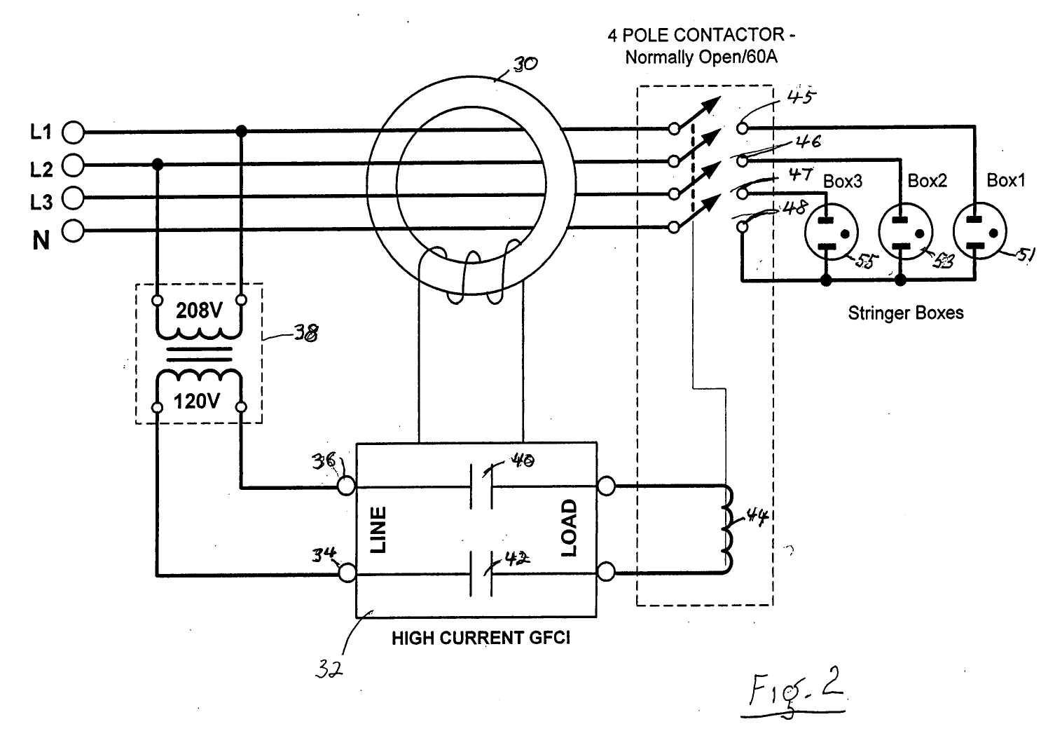

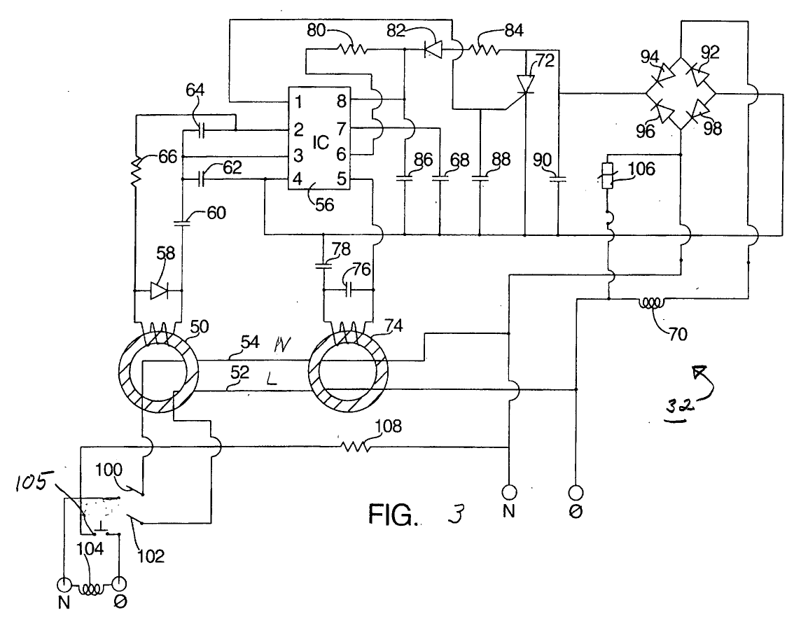

As shown in FIGS. 2 and 5, the inductance loop 30 comprises two transformers, the differential transformer DT and the neutral transformer NT mounted adjacent to each other and having a 3 phase voltage carrying capability of 208 volts. As shown in FIG. 2, three phase conductors L1, L2 and L3, and a neutral conductor N pass through inductance loop 30. Each of these conductors provides a primary winding for each of the two transformers of inductance loop 30. The secondary windings of each of the transformers are connected to various components and an integrated circuit 56 of the GFCI 32, as shown in detail in FIG. 3. Also shown in FIG. 2, terminals 34, 36 of the GFCI are connected to receive 120 volt, 60 Hz signal needed to power the ground fault circuit interrupter. In this invention, the input terminals 34, 36 of the ground fault circuit interrupter are connected to the secondary winding of step down transformer 38 and the primary winding of transformer 38 is connected to receive power from any two of the three phase conductors L1, L2, L3. In FIG. 2, the primary winding of step down transformer 38 is connected across phase conductors L1 and L2 to step down the 208 input voltage to 120 volt output voltage which is the input voltage for the circuitry of the ground fault circuit interrupter.

When a fault is detected such as an open neutral, a phase conductor to ground, a neutral to ground, etc is sensed by the GFCI, contacts 40, 42 of the GFCI open which de-energizes the coil 44 of the contactor. When coil 44 is de-energized, normally open contacts 45, 46, 47 and 48 snap open to disconnect the flow of current in conductors L1, L2, L3 and N to the loads connected to stringer Boxes 51, 53 and 55.

Referring to FIG. 3, there is shown a schematic diagram of a basic ground fault circuit interrupter circuit which can be used in the GFCI of FIG. 2. It is to be noted that the circuit of FIG. 3 does not show the feature of this invention where the transformer coils in the inductance loop are separately compartmentalized from the ground fault interrupter circuitry which is capable of carrying voltages of at least 208 volts, and utilizes a set of contacts located in the ground fault circuit interrupter to de-energize the coils of a contactor having the capability of interrupting current of up to 50 amps.

The circuit of FIG. 3, which is limited to a single phase circuit of 120 volts line to ground and which can be found in the prior art, is shown to explain the operation of the present invention.

Referring to FIG. 3, differential transformer 50 monitors the flow of current in line and neutral conductors 52 and 54, respectively, and produces in its secondary a fault signal when the total current in the line conductor 52 does not equal the current in the neutral conductor 54. This fault signal is fed through the diode 58, capacitors 60, 62 and 64, and resistor 66 to integrated circuit 56. Integrated circuit 56 may be a type ML 1851 Ground Fault Interrupter manufactured by National Semiconductor Corporation.

In the circuit of FIG. 3, the combination of diode 58 and resistor 66 promotes quick discharge of capacitor 60 which allows integrated circuit 56 to be kept continuously energized to reduce the time required to detect a fault. This occurs because capacitor 68, which is attached to output pin 7 of integrated circuit 56, and which basically controls the trip circuit, would otherwise cause SCR 72 to fire frequently which, in turn, could possibly cause the trip coil 70 to burn out by being frequently energized.

On a neutral to ground fault the circuit of FIG. 3 functions somewhat similar in that transformer 74, which together with differential transformer 50 forms part of the induction loop 30 (see FIG. 2), which as previously indicated is mounted remotely from the ground fault interrupter circuitry in such a fashion that high current cables can be carried there through, has a signal induced on its secondary windings which is fed through the circuit having capacitors 76 and 78 to input pin 4 of integrated circuit 56.

The trip circuit for both types of faults is identical in that if a fault is detected by the input pins 2, 3 and 4 of IC 56, a signal is output from pin 7 of integrated circuit 56 to cause capacitor 68 to charge faster. At the same time, the path to the gate of SCR 72 which includes resistors 80 and 84, diode 82, and capacitors 86 and 88 is energized. Shortly thereafter, SCR 72 conducts and an energization path to trip coil 70 is created through diode bridge 92, 94, 96 and 98. Capacitor 90 and MOV 106 are present for surge protection.

Upon energization of trip coil 70, contacts 100 and 102 of the ground fault circuit interrupter which are equivalent to the normally open GFCI contacts 40, 42 of FIG. 2, open to deactivate contactor coil 70 (equivalent to contactor coil 44 of FIG. 2) which causes contacts (not shown) to open and disconnect one or more high current conductors from the stringer boxes shown in FIG. 2.

A push button 105 and resistor 108 in FIG. 3 are part of a test circuit which bypasses the transformers 50 and 74. Also, since the ground fault circuit interrupter shown in FIG. 2 is only sensitive to differences in current flow between the “hot” conductors and the neutral conductor or the neutral conductor and ground, unbalanced loading between “hot” conductors will not cause nuisance tripping.

In the invention disclosed, the differential transformer and neutral transformer are mounted adjacent to each other and separately compartmentalized from the ground fault circuit interrupter to allow the passage of heavy duty cables capable of carrying high currents of at least 50 amps and where the contactor coil of a ground fault circuit interrupter is used to interrupter the flow of the high current in the heavy duty cables. In addition, in this invention the transformers of the induction loop 10 (of FIG. 2) can handle at least 208 volts AC whether line to ground or line to line, and the flow of current in the heavy duty cables can be interrupted at a location that is remote from the GFCI by positioning the contactor of the GFCI and its contacts at the remote location.

This is in contrast with prior art devices wherein the ground fault circuit interrupter circuitry was installed in the lines to be monitored and thus limited the current levels that could be monitored. In this invention, the transformers in inductance loop 10 can see voltages of at least 208 volts but they in turn pass only a small current induced in the secondary windings of the transformers DT and NT to the GFCI 12.

An additional feature of the invention is that the circuit interrupting means may be installed at a location remote form the sensing control circuitry, For example, as shown in FIG. 6, the GFCI 12′ in its housing compartment can be mounted on a control panel 26 at a first location and thus made accessible to a user, while the contactor 18, the transformers DT and NT in compartment 14 and the conductors 22 are mounted closer to the load at a location remote from the user. This arrangement protects the transformers, particularly the differential transformer, from exposure to electrical noise in the vicinity of the remote location. If desired, a switch 23 can be employed to open the neutral line N. This can be done in both a two and three phase system.

This invention is directed toward a ground fault circuit interrupter which can provide open neutral sensing and protection. In the prior art, for single phase power applications, a continuous relay with power-line drive is used to sense for a broken power supply conductor. But, when this method is used with multi-phase circuits such as a 3 phase circuit, the relay may not drop out when the neutral conductor of the 3 phase circuit becomes discontinuous. Furthermore, if an unbalanced loading on the system should now occur, the GFCI may not be capable of providing ground fault protection. The open neutral sensing and unbalanced loading problems are solved by using the power from two phase conductors to power the GFCI.

As disclosed above, a single high current GFCI such as the High Current GFCI by Leviton, is coupled to receive power from two phase lines of a 3 phase circuit through a step down transformer, and the GFCI is coupled to control the relay coil of a 4 pole contactor. When an open neutral fault occurs, as the GFCI is receiving its power from two phase conductors, the GFCI power is not interrupted and continues to provide ground fault protection.

While there have been shown and described and pointed out the fundamental novel features of the invention as applied to the preferred embodiments, it will be understood that various omissions and substitutions and changes of the form and details of the method and apparatus illustrated and in the operation may be done by those skilled in the art, without departing from the spirit of the invention.

What is claimed is:

1. Apparatus for providing open neutral protection to a 3 phase circuit having 3 phase conductors and a neutral conductor comprising:
a GFCI having input terminals for receiving a voltage to power the circuit of the GFCI and an inductance loop, said inductance loop coupled to said three phase conductors and said neutral conductor of said 3 phase circuit; and
voltage reducing means interposed between said 3 phase circuit and said input terminals of said GFCI for providing a reduced voltage from two of said phase conductors of said 3 phase circuit to said input terminals to power the circuit of said GFCI.

2. The apparatus of claim 1 wherein said GFCI comprises a high current GFCI.

3. The apparatus of claim 2 wherein said circuitry of said GFCI is located in a first compartment and said inductance loop comprises a differential transformer and a neutral transformer located in a second compartment.

4. The apparatus of claim 3 wherein said first compartment is located in close proximity to said second compartment.

5. The apparatus of claim 3 wherein said first compartment is located remotely from said second compartment.

6. The apparatus of claim 1 wherein said voltage reducing means comprises a step down transformer.

7. The apparatus of claim 6 wherein said GFCI comprises a high current GFCI.
